(19) United States
(12) Patent Application Publication
(10) Pub. No.: US 2022/0200044 A1
(43) Pub. Date: Jun. 23, 2022

(54) ALL-SOLID-STATE BATTERY AND METHOD FOR MANUFACTURING SAME

(71) Applicant: Panasonic Intellectual Property Management Co., Ltd., Osaka (JP)

(72) Inventors: SHUZO TSUCHIDA, Nara (JP); AKIHIRO HORIKAWA, Osaka (JP); TAKESHI KOIWASAKI, Osaka (JP)

(21) Appl. No.: 17/522,964

(22) Filed: Nov. 10, 2021

(30) Foreign Application Priority Data
Dec. 23, 2020 (JP) 2020-213610

(51) Int. Cl. H01M 10/0562; H01M 10/0585

(52) U.S. Cl. CPC H01M 10/0562; H01M 2300/0068; H01M 2300/0094; H01M 10/0585

(57) ABSTRACT

All-solid-state battery 100 has a structure in which positive electrode current collector 6, positive electrode layer 20 containing positive electrode active material 3 and solid electrolyte 1, solid electrolyte layer 10 containing solid electrolyte 2, negative electrode layer 30 containing negative electrode active material 4 and solid electrolyte 5, and negative electrode current collector 7 are stacked in this order. Solid electrolyte 2 contains first material 21 and second material 22 having an ionic conductivity lower than an ionic conductivity of first material 21. First material 21 includes first particles 40, and at least a part of a surface of first particles 40 is covered with second material 22.

### BACKGROUND

### 1. Technical Field

The present disclosure relates to an all-solid-state battery and a method for manufacturing the same, and more particularly to an all-solid-state battery using a positive electrode layer, a negative electrode layer, and a solid electrolyte layer, and a method for manufacturing the same.

### 2. Description of the Related Art

In recent years, development of a secondary battery that can be repeatedly used has been required due to weight reduction, cordless extension, or the like of electronic devices such as personal computers and mobile phones. Examples of the secondary battery include a nickel-cadmium battery, a nickel hydrogen battery, a lead-acid battery, and a lithium-ion battery. Among these batteries, the lithium ion battery has characteristics such as a light weight, a high voltage, and a high energy density, and is thus attracting attention.

In an automobile field such as an electric vehicle or a hybrid vehicle, the development of a secondary battery having a high battery capacity is important, and a demand for the lithium ion battery tends to increase.

The lithium ion battery is formed of a positive electrode layer, a negative electrode layer, and an electrolyte disposed between the positive electrode layer and the negative electrode layer, and a solid electrolyte or an electrolyte solution obtained by dissolving a supporting salt such as lithium hexafluorophosphate in an organic solvent is used for the electrolyte. Currently, a widely used lithium ion battery is combustible since the electrolytic solution containing the organic solvent is used. Therefore, a material, a structure, and a system for ensuring the safety of the lithium ion battery are required. On the other hand, it is expected that by using a nonflammable solid electrolyte as the electrolyte, the material, the structure, and the system described above can be simplified, and it is thought that an energy density can be increased, a manufacturing cost can be reduced, and productivity can be improved. Hereinafter, a battery using the solid electrolyte, such as the lithium ion battery using the solid electrolyte, will be referred to as an “all-solid-state battery”.

The solid electrolyte can be roughly divided into an organic solid electrolyte and an inorganic solid electrolyte. The organic solid electrolyte has an ionic conductivity of about 10⁻⁶ S/cm at 25° C., the ionic conductivity is extremely low as compared with an ionic conductivity of about 10⁻³ S/cm of an electrolytic solution. Therefore, it is difficult to operate the all-solid-state battery using the organic solid electrolyte in an environment of 25° C. As the inorganic solid electrolyte, an oxide-based solid electrolyte, a sulfide-based solid electrolyte, and a halide-based solid electrolyte are generally used. The ionic conductivity of these solid electrolytes is about 10⁻⁴ S/cm to 10⁻³ S/cm, which is a relatively high ionic conductivity. Therefore, in the development of the all-solid-state battery directed to a large size and a high capacity, studies of an all-solid-state battery enabling a large size using a sulfide-based solid electrolyte or the like have been actively conducted in the recent years.

For example, Japanese Patent Unexamined Publication No. 2013-157084 discloses a method of forming a solid electrolyte layer having a high filling rate in which voids between particles of a solid electrolyte constituting a solid electrolyte layer of an all-solid-state battery are filled. In the method described in Japanese Patent Unexamined Publication No. 2013-157084, small particles are filled in voids between large particles by using electrolyte particles having two types of, i.e., large and small, particle diameters as the electrolyte particles constituting the solid electrolyte layer.

### SUMMARY

An all-solid-state battery according to an aspect of the present disclosure includes: a positive electrode current collector; a positive electrode layer containing a positive electrode active material and a first solid electrolyte; a solid electrolyte layer containing a third solid electrolyte; a negative electrode layer containing a negative electrode active material and a second solid electrolyte; and a negative electrode current collector, in which the positive electrode current collector, the positive electrode layer, the solid electrolyte layer, the negative electrode layer, and the negative electrode current collector are stacked in this order, the third solid electrolyte contains a first material and a second material having an ionic conductivity lower than an ionic conductivity of the first material, the first material includes first particles, and at least a part of a surface of the first particles is covered with the second material.

### BRIEF DESCRIPTION OF THE DRAWINGS

FIG. 1 is a schematic view showing a cross section of an all-solid-state battery according to an embodiment;

FIG. 2 is a schematic cross-sectional view illustrating a method for manufacturing an all-solid-state battery according to the embodiment;

FIG. 3 is a schematic view showing a mixing behavior of first particles and second particles in the embodiment;

FIG. 4 is a schematic view showing a cross section of an evaluation sample used in Comparative Example 1 and Example 2;

FIG. 5 is a schematic view illustrating a generation state of dendrites in the evaluation sample in Comparative Example 1;

FIG. 6 is a schematic view illustrating a generation state of dendrites in the evaluation sample in Example 1;

FIG. 7A is a perspective view schematically showing a state where the first particles are covered with the second particles in the embodiment;

FIG. 7B is a cross-sectional view of the first particles and the second particles shown in FIG. 7A cut at a surface VIIb; and

FIG. 8 is a table showing a time required from a start of application of a constant current to a short circuit.

### DETAILED DESCRIPTION

In general, in an all-solid-state battery, metal lithium (Li) is precipitated on a surface of a negative electrode active material constituting a negative electrode layer due to repetition of battery charge and discharge, and the metal Li gradually grows along a particle surface of particles of a solid electrolyte material constituting a solid electrolyte layer and an interface between the particles. As a result, there arises a problem that the grown metal Li causes a short circuit due to electrical conduction between a positive electrode layer and the negative electrode layer. Hereinafter, a metal such as the grown metal Li may be referred to as “dendrite”.

Therefore, the present disclosure provides an all-solid-state battery or the like that can prevent an occurrence of the short circuit due to the repetition of the battery charge and discharge.

An all-solid-state battery according to an aspect of the present disclosure has a structure in which a positive electrode current collector, a positive electrode layer containing a positive electrode active material and a first solid electrolyte, a solid electrolyte layer containing a third solid electrolyte, a negative electrode layer containing a negative electrode active material and a second solid electrolyte, and a negative electrode current collector are stacked in this order, in which the third solid electrolyte contains a first material and a second material having an ionic conductivity lower than an ionic conductivity of the first material, the first material includes first particles, and at least a part of a surface of the first particles is covered with the second material.

According to the all-solid-state battery or the like of the present disclosure, the occurrence of the short circuit due to the repetition of the battery charge and discharge can be prevented.

For example, during charge and discharge of the all-solid-state battery, since conduction of ions such as Li ions moving in the first particles is hindered by the second material covering the first particles, generation of metal growth (dendrite) such as metal Li in the solid electrolyte layer is multi-branched. As a result, the dendrite extending from the positive electrode layer is less likely to reach the negative electrode layer. Therefore, the all-solid-state battery according to the present aspect can prevent the occurrence of the short circuit. In the all-solid-state battery according to the present aspect, a battery life is prolonged by lengthening the time until the short circuit occurs.

For example, a coverage rate of the second material on the at least a part of the surface of the first particles may be 5% or more and 62% or less.

Accordingly, an increase in resistance component in ionic conduction in the solid electrolyte layer is prevented, so that a short circuit preventing effect can be obtained while preventing a decrease in battery characteristics.

For example, the second material may include second particles having an average particle diameter smaller than an average particle diameter of the first particles.

Accordingly, the first particles partially covered with the second material can be easily obtained, and a mixing ratio of the first material and the second material is likely to be controlled, so that stable battery performance can be obtained.

For example, a ratio of the average particle diameter of the second particles to the average particle diameter of the first particles may be 1% or more and 20% or less.

Accordingly, the surface of the first particles is likely to be covered with the second material composed of the second particles, a covering structure of the second material can be easily formed, complexity of manufacturing the all-solid-state battery can be reduced, and the manufacturing can be stably performed.

For example, in the covering structure of the second material covering the first particles, a covering length with respect to a covering thickness may be 10 times or more.

Accordingly, the short circuit preventing effect can be obtained while preventing the increase in resistance component in ionic conduction in a thickness direction of the covering structure of the second material.

For example, a volume ratio of the second material to a total volume of the first material and the second material may be 5% or more and 50% or less.

Accordingly, the short circuit preventing effect can be obtained while preventing the increase in resistance component in the ionic conduction in the solid electrolyte layer.

For example, in a cross-sectional view of the solid electrolyte layer, a variation in a volume ratio of the second material to a total volume of the first material and the second material in a thickness direction of the solid electrolyte layer may be 10% or less.

Accordingly, bias of the ionic conduction in the solid electrolyte layer is less likely to occur, and stable battery charge and discharge characteristics can be obtained even when a charge and discharge rate is high.

For example, a content ratio of oxygen in the second material may be higher than a content rate of oxygen in the first material.

Accordingly, by increasing an oxygen content in the second material by oxidizing the solid electrolyte material or the like, the ionic conductivity of the second material tends to be low, and therefore, the second material having an ionic conductivity lower than that of the first material can be easily obtained.

For example, a ratio of the ionic conductivity of the second material to the ionic conductivity of the first material may be 0.2% or more and 10% or less.

Accordingly, the short circuit preventing effect can be obtained while preventing the increase in resistance component in the ionic conduction in the solid electrolyte layer.

In addition, a method for manufacturing the all-solid-state battery according to the aspect of the present disclosure includes: a stirring and kneading step of forming the third solid electrolyte by kneading the first material and the second material in a dry manner by applying a pressing force and a shearing force before forming the solid electrolyte layer.

Accordingly, since the first material and the second material are kneaded before forming the solid electrolyte layer, a structure in which the surface of the first particles is covered with the second material is formed, and such a covering structure is stabilized. Therefore, it is possible to manufacture an all-solid-state battery in which the short circuit preventing effect is enhanced.

For example, the manufacturing method may further include: a grinding step of forming the second material by grinding the first material in presence of oxygen before the stirring and kneading step.

By exposing the first material in an oxygen atmosphere, a material obtained by reducing the ionic conductivity of the first material can be used as the second material, and the first material and the second material can be manufactured using the same material. Therefore, the second material can be easily prepared.

Hereinafter, the all-solid-state battery according to an embodiment will be described in detail. Each of the embodiments described below shows a comprehensive or specific example. Numerical values, shapes, materials, constituent elements, arrangement positions and connection forms of the constituent elements, processes, and the like described in the following embodiments are examples, and are not intended to limit the present disclosure.

In the present specification, terms indicating a relationship between elements such as parallel, terms indicating a shape of elements such as a rectangle, and numerical value ranges are not expressions expressing only strict meanings, and are expressions that mean substantially equivalent ranges, which cover, for example, a difference of about several percent.

Each drawing is a schematic view that is appropriately emphasized, omitted, or adjusted in proportion to show the present disclosure, and is not necessarily exactly illustrated and may differ from an actual shape, positional relationship, and ratio. In the drawings, substantially the same components are denoted by the same reference numerals, and redundant description may be omitted or simplified.

In the present specification, terms “up” and “down” in the configuration of the all-solid-state battery do not refer to an upward direction (vertically upward direction) and a downward direction (vertically downward direction) in absolute space recognition, and are used as terms that are defined by a relative positional relationship based on a stacking order in a stacked configuration. Further, the terms “up” and “down” are applied not only to a case where two constituent elements are arranged in close contact with each other and the two constituent elements come into contact with each other, but also to a case where two constituent elements are arranged with a gap therebetween and another constituent element is present between the two constituent elements.

In the present specification, a cross-sectional view is a view showing a cross section in a case where a central portion of the all-solid-state battery is cut in a stacking direction.

### Embodiment

### Configuration

### A. All-Solid-State Battery

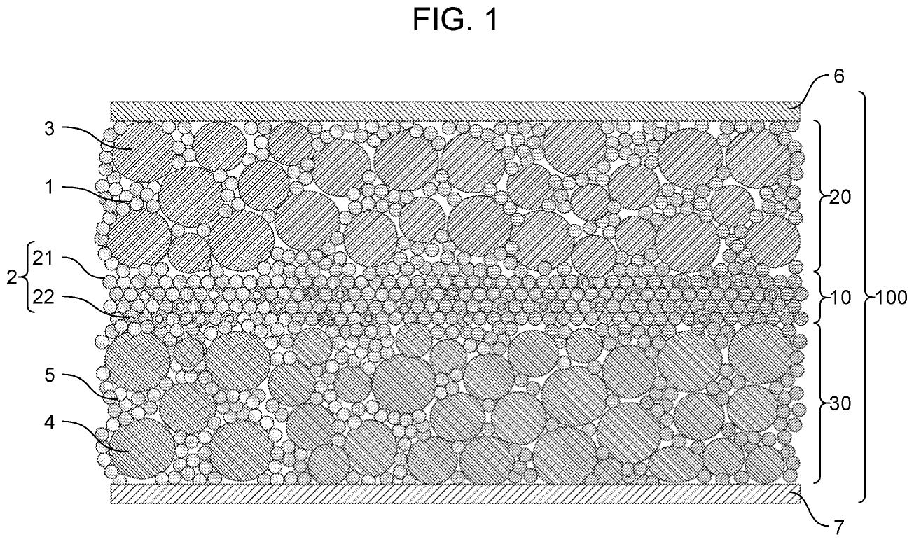

An overview of the all-solid-state battery according to the present embodiment will be described with reference to FIG. 1. FIG. 1 is a schematic view showing a cross section of all-solid-state battery 100 according to the present embodiment. All-solid-state battery 100 according to the present embodiment includes positive electrode current collector 6, negative electrode current collector 7, positive electrode layer 20 formed on a surface of positive electrode current collector 6 close to negative electrode current collector 7 and containing positive electrode active material 3 and solid electrolyte 1, negative electrode layer 30 formed on a surface of negative electrode current collector 7 close to positive electrode current collector 6 and containing negative electrode active material 4 and solid electrolyte 5, and solid electrolyte layer 10 disposed between positive electrode layer 20 and negative electrode layer 30 and containing at least solid electrolyte 2 having ionic conductivity. In other words, all-solid-state battery 100 has a structure in which positive electrode current collector 6, positive electrode layer 20, solid electrolyte layer 10, negative electrode layer 30, and negative electrode current collector 7 are stacked in this order. In the present embodiment, solid electrolyte 1 is an example of the first solid electrolyte, solid electrolyte 5 is an example of the second solid electrolyte, and solid electrolyte 2 is an example of the third solid electrolyte.

In the present embodiment, solid electrolyte 2 contained in solid electrolyte layer 10 is composed of a mixture of at least two types of solid electrolytes having different ionic conductivities, and is specifically composed of first material 21 made of a solid electrolyte material and second material 22 made of a solid electrolyte material having an ionic conductivity lower than that of first material 21. First material 21 is formed by collection of particles of a solid electrolyte material. In addition, second material 22 is also formed by collection of particles of a solid electrolyte material, but in FIG. 1, a state of a film in which particles of second material 22 (that is, second particles described later) are densely formed is shown. Therefore, in FIG. 1, a shape of the particles of second material 22 is not illustrated. At least a part of the surface of particles of first material 21 (that is, first particles described later) is in contact with second material 22 and is covered with second material 22. Second material 22 may be formed of a solid electrolyte material having a layer shape, a film shape, or the like.

All-solid-state battery 100 is formed by the following method, for example. First, positive electrode layer 20 formed on positive electrode current collector 6 made of a metal foil and containing positive electrode active material 3, negative electrode layer 30 formed on negative electrode current collector 7 made of the metal foil and containing negative electrode active material 4, and solid electrolyte layer 10 disposed between positive electrode layer 20 and negative electrode layer 30 and containing solid electrolyte 2 having ionic conductivity are formed. Then, pressing is performed from outer sides of positive electrode current collector 6 and negative electrode current collector 7 at a pressure of, for example, 100 MPa or more and 1000 MPa or less, and a filling rate of at least one layer of layers is 60% or more and less than 100%, whereby all-solid-state battery 100 is obtained. By setting the filling rate to 60% or more, since voids are reduced in solid electrolyte layer 10, positive electrode layer 20, or negative electrode layer 30, lithium (Li) ion conduction and electron conduction are often performed, and good charge and discharge characteristics can be obtained. The filling rate is a ratio of a volume occupied by the material excluding the voids between the materials to a total volume in each layer.

Pressed all-solid-state battery 100 is attached with a terminal, for example, and is housed in a case. As the case of all-solid-state battery 100, for example, an aluminum laminate bag, a metal case such as stainless steel (SUS), iron or aluminum, or a resin case is used.

Hereinafter, solid electrolyte layer 10, positive electrode layer 20, and negative electrode layer 30 of all-solid-state battery 100 in the present embodiment will be described.

### B. Solid Electrolyte Layer

First, solid electrolyte layer 10 will be described. Solid electrolyte layer 10 in the present embodiment includes solid electrolyte 2, and may further contain a binder.

### B-1. Solid Electrolyte

Solid electrolyte 2 in the present embodiment will be described. Solid electrolyte 2 contains at least first material 21 made of a solid electrolyte material having a high ionic conductivity and second material 22 made of a solid electrolyte material having a low ionic conductivity. The ionic conductivity of second material 22 is lower than the ionic conductivity of first material 21. Details regarding shape characteristics of first material 21 and second material 22 will be described later.

Examples of the solid electrolyte material used for first material 21 and second material 22 constituting solid electrolyte 2 include a sulfide-based solid electrolyte, a halide-based solid electrolyte, and an oxide-based solid electrolyte, which are commonly known materials. As the solid electrolyte material, any of the sulfide-based solid electrolyte, the halide-based solid electrolyte, and the oxide-based solid electrolyte may be used. A type of the sulfide-based solid electrolyte in the present embodiment is not particularly limited. Examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, from the viewpoint of excellent ionic conductivity of lithium, the sulfide-based solid electrolyte may contain Li, P, and S. Further, the sulfide-based solid electrolyte may contain P₂S₅ since reactivity with the binder is high and bondability with the binder is high. The above description of “Li₂S—P₂S₅” means a sulfide-based solid electrolyte using a raw material composition containing Li₂S and P₂S₅, and the same applies to other descriptions.

In the present embodiment, the sulfide-based solid electrolyte is, for example, a sulfide-based glass ceramic containing Li₂S and P₂S₅, and a ratio of Li₂S and P₂S₅ may be in a range of 70:30 to 80:20 or in a range of 75:25 to 80:20 for Li₂S:P₂S₅ in terms of molars. By setting the ratio of Li₂S and P₂S₅ within the above range, a crystal structure having high ionic conductivity can be obtained while maintaining a Li concentration that influences the battery characteristics. Further, by setting the ratio of Li₂S and P₂S₅ within the above range, an amount of P₂S₅ for reacting with and binding to the binder is likely to be ensured.

As described above, solid electrolyte 2 contains at least first material 21 and second material 22 which are two types of solid electrolyte materials having different ionic conductivities.

At least a part of the surface of the particles of the solid electrolyte material constituting first material 21 (that is, the first particles described later) is covered with second material 22. Second material 22 partially covers the surface of the particles of first material 21, for example. A part of second material 22 may not cover the surface of the particles of first material 21. In addition, solid electrolyte 2 may contain a solid electrolyte material other than first material 21 and second material 22.

### B-2. Binder

The binder in the present embodiment will be described. The binder is an adhesive material that does not have ionic conductivity and electron conductivity and plays a role of bonding the materials in solid electrolyte layer 10 and solid electrolyte layer 10 to other layers. As the binder, a known binder for a battery is used. In addition, the binder in the present embodiment may contain a thermoplastic elastomer in which a functional group for improving adhesion strength is introduced. In addition, the functional group may be a carbonyl group. From the viewpoint of improving the adhesion strength, the carbonyl group may be maleic anhydride. Oxygen atoms of the maleic anhydride of the binder react with solid electrolyte 2 to bond solid electrolytes 2 to each other via the binder, thereby forming a structure in which the binder is disposed between solid electrolytes 2. As a result, the adhesion strength is improved.

Examples of the thermoplastic elastomer include styrene-butadiene-styrene (SBS) and styrene-ethylene-butadiene-styrene (SEBS). These materials can be used since these materials have high adhesion strength and have high durability even in cycle characteristics of the battery. As the thermoplastic elastomer, a hydrogenation-added (hereinafter, hydrogenated) thermoplastic elastomer may be used. By using the hydrogenated thermoplastic elastomer, the reactivity and the bondability are improved, and solubility in a solvent used for forming solid electrolyte layer 10 is improved.

An addition amount of the binder is, for example, 0.01 mass % or more and 5 mass % or less, may be 0.1 mass % or more and 3 mass % or less, and may be 0.1 mass % or more and 1 mass % or less. When the addition amount of the binder is set to 0.01 mass % or more, bonding via the binder is likely to occur, and sufficient adhesion strength is likely to be obtained. In addition, when the addition amount of the binder is set to 5 mass % or less, the decrease in battery characteristics such as charge and discharge characteristics is unlikely to occur, and even when physical properties such as hardness, tensile strength, and tensile elongation of the binder are changed in a low temperature region, for example, the charge and discharge characteristics are unlikely to decrease.

### C. Positive Electrode Layer

Next, positive electrode layer 20 in the present embodiment will be described. Positive electrode layer 20 in the present embodiment contains solid electrolyte 1 and positive electrode active material 3. If necessary, a binder and a conductive aid such as acetylene black and Ketjen black (registered trademark) for ensuring electron conductivity may be added to positive electrode layer 20. However, when the addition amount is large, the battery performance is influenced, so it is desirable that the addition amount is small enough not to influence the battery performance. A weight ratio of solid electrolyte 1 to positive electrode active material 3 is, for example, in a range of 50:50 to 5:95 for solid electrolyte 1:positive electrode active material 3, and may be in a range of 30:70 to 10:90. In addition, the volume ratio of positive electrode active material 3 to the total volume of positive electrode active material 3 and solid electrolyte 1 is, for example, 60% or more and 80% or less. With this volume ratio, both a lithium ion conduction path and an electron conduction path in positive electrode layer 20 are likely to be ensured.

Positive electrode current collector 6 is made of, for example, a metal foil. As the metal foil, for example, a metal foil of SUS, aluminum, nickel, titanium, or copper is used.

### C-1. Solid Electrolyte

Solid electrolyte 1 is optionally selected from at least one solid electrolyte material described in the above B-1. Solid Electrolyte, and others are not particularly limited. For solid electrolyte 1, for example, the solid electrolyte material as same that in first material 21 is used.

### C-2. Binder

Since the binder is the same as the binder described above, the description thereof will be omitted.

### C-3. Positive Electrode Active Material

Positive electrode active material 3 in the present embodiment will be described. As the material of positive electrode active material 3 in the present embodiment, for example, a lithium-containing transition metal oxide is used. Examples of the lithium-containing transition metal oxide include LiCoO₂, LiNiO₂, LiMn₂O₄, LiCoPO₄, LiNiPO₄, LiFePO₄, LiMnPO₄, and a compound obtained by substituting the transition metal of the above compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compound obtained by substituting the transition metal of the above compounds with one or two different elements. The materials of positive electrode active material 3 may be used alone or in combination of two or more thereof.

Positive electrode active material 3 includes, for example, collection of particles. The particles of positive electrode active material 3 are granulated particles in which a plurality of primary particles made of the above material are collected, and in the present specification, these granulated particles are referred to as the particles of positive electrode active material 3. An average particle diameter of the particles of positive electrode active material 3 is not particularly limited, and is, for example, 1 μm or more and 10 μm or less.

### D. Negative Electrode Layer

Next, negative electrode layer 30 in the present embodiment will be described. Negative electrode layer 30 of the present embodiment contains solid electrolyte 5 and negative electrode active material 4. If necessary, a binder and a conductive aid such as acetylene black and Ketjen black for ensuring electron conductivity may be added to negative electrode layer 30. However, when the addition amount is large, the battery performance is influenced, so it is desirable that the addition amount is small enough not to influence the battery performance. The ratio of solid electrolyte 5 to negative electrode active material 4 is, for example, in a range of 5:95 to 60:40 for solid electrolyte 5:negative electrode active material 4 in terms of weight, and may be in a range of 30:70 to 50:50. In addition, the volume ratio of negative electrode active material 4 to the total volume of negative electrode active material 4 and solid electrolyte 5 is, for example, 60% or more and 80% or less. With this volume ratio, both a lithium ion conduction path and an electron conduction path in negative electrode layer 30 are likely to be ensured.

Negative electrode current collector 7 is made of, for example, a metal foil. As the metal foil, for example, a metal foil such as SUS, copper, or nickel is used.

### D-1. Solid Electrolyte

Solid electrolyte 5 is optionally selected from at least one solid electrolyte material described in the above B-1. Solid Electrolyte, and others are not particularly limited. For solid electrolyte 5, for example, the solid electrolyte material same as that in first material 21 is used.

### D-2. Binder

Since the binder is the same as the binder described above, the description thereof will be omitted.

### D-3. Negative Electrode Active Material

Negative electrode active material 4 in the present embodiment will be described. As the material of negative electrode active material 4 in the present embodiment, for example, known materials such as an easily alloyed metal with lithium such as indium, tin, and silicon, a carbon material such as hard carbon and graphite, lithium, or Li₄Ti₅O₁₂ and SiOₓ are used.

Negative electrode active material 4 includes, for example, collection of particles. An average particle diameter of the particles of negative electrode active material 4 is not particularly limited, and is, for example, 1 μm or more and 15 μm or less.

### Manufacturing Method

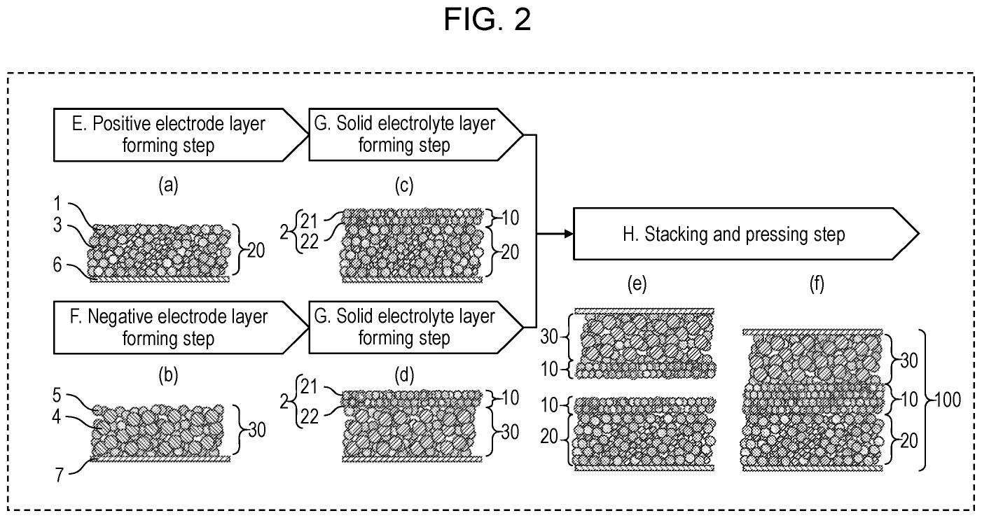

Next, a method for manufacturing all-solid-state battery 100 according to the present embodiment will be described with reference to FIG. 2. Specifically, the method for manufacturing all-solid-state battery 100 including solid electrolyte layer 10, positive electrode layer 20, and negative electrode layer 30 will be described. FIG. 2 is a schematic cross-sectional view illustrating the method for manufacturing all-solid-state battery 100.

The method for manufacturing all-solid-state battery 100 includes, for example, a positive electrode layer forming step, a negative electrode layer forming step, a solid electrolyte layer forming step, a stacking step, and a pressing step. In the positive electrode layer forming step ((a) in FIG. 2), positive electrode layer 20 is formed on positive electrode current collector 6. In the negative electrode layer forming step ((b) in FIG. 2), negative electrode layer 30 is formed on negative electrode current collector 7. In the solid electrolyte layer forming step ((c) and (d) in FIG. 2), solid electrolyte layer 10 is formed. In the stacking step and the pressing step ((e) and (f) in FIG. 2), positive electrode layer 20 formed on positive electrode current collector 6, negative electrode layer 30 formed on negative electrode current collector 7, and formed solid electrolyte layer 10 are stacked together such that solid electrolyte layer 10 is disposed between positive electrode layer 20 and negative electrode layer 30, and pressing is performed from the outer sides of positive electrode current collector 6 and negative electrode current collector 7. In addition, the method for manufacturing all-solid-state battery 100 includes, for example, a stirring and kneading step of forming solid electrolyte 2 by kneading first material 21 and second material 22 in a dry manner by applying a pressing force and a shearing force before forming solid electrolyte layer 10. Hereinafter, each step will be described in detail.

### E. Positive Electrode Layer Forming Step

Examples of the step of forming positive electrode layer 20 (positive electrode layer forming step) in the present embodiment include the following two methods of method (1) and method (2).

(1) Positive electrode layer 20 in the present embodiment can be prepared by, for example, the step including a coating step of coating a slurry positive electrode mixture, which is prepared by dispersing positive electrode active material 3 and solid electrolyte 1 in an organic solvent, and further dispersing a binder and a conductive aid (not shown) in the organic solvent as necessary, onto the surface of positive electrode current collector 6, a drying and firing step of removing the organic solvent by heating and drying the obtained coating film, and a coating film pressing step of pressing the dried coating film formed on positive electrode current collector 6.

A coating method for the slurry is not particularly limited, and examples thereof include known coating methods such as a blade coater, a gravure coater, a dip coater, a reverse coater, a roll knife coater, a wire bar coater, a slot die coater, an air knife coater, a curtain coater, an extrusion coater, and a combination thereof.

Examples of the organic solvent used for slurring include, but are not limited to, heptane, xylene, and toluene, and a solvent that does not cause a chemical reaction with positive electrode active material 3 or the like may be appropriately selected.

The drying and firing step is not particularly limited as long as the organic solvent can be removed by drying the coating film, and a known drying method or firing method using a heater or the like may be adopted. The coating film pressing step is not particularly limited, and a known pressing step using a press machine or the like may be adopted.

(2) In addition, as another method of forming positive electrode layer 20 in the present embodiment, for example, a method including a mixture adjusting step, a powder stacking step, and a powder pressing step can be mentioned. In the mixture adjusting step, solid electrolyte 1 and positive electrode active material 3 in a powder state which are not slurried are prepared, a binder and a conductive aid (not shown) are further prepared as necessary, and the prepared materials are mixed while applying appropriate shear and pressure to prepare the positive electrode mixture in which positive electrode active material 3 and solid electrolyte 1 are uniformly dispersed. In the powder stacking step, the obtained positive electrode mixture is uniformly stacked on positive electrode current collector 6 to obtain a stacked body. In the powder pressing step, the stacked body obtained in the powder stacking step is pressed.

When the positive electrode mixture in a powder state is manufactured in a stacked form, there is an advantage that a drying step is not necessary and a manufacturing cost is reduced, and the solvent that contributes to the battery performance of the all-solid-state battery does not remain in positive electrode layer 20 after formation.

### F. Negative Electrode Layer Forming Step

The step of forming negative electrode layer 30 (negative electrode layer forming step) in the present embodiment is basically the same as the above E. Positive Electrode Layer Forming Step in the forming method except that the material to be used is changed to a material for negative electrode layer 30.

A method for manufacturing negative electrode layer 30 may be, for example, a method in which a negative electrode mixture obtained by mixing solid electrolyte 5, negative electrode active material 4, and a binder and a conductive aid (not shown) as necessary to form a slurry is coated onto negative electrode current collector 7 and then dried (method (1) in E. Positive Electrode Layer Forming Step). In addition, the method for manufacturing negative electrode layer 30 may be, for example, a method in which the negative electrode mixture in a powder state which is not slurried is stacked on negative electrode current collector 7 (method (2) in E. Positive Electrode Layer Forming Step).

When the negative electrode mixture in a powder state is manufactured in a stacked manner, there is an advantage that the drying step is not necessary and the manufacturing cost is reduced, and the solvent that contributes to a capacity of the all-solid-state battery does not remain in negative electrode layer 30 after formation.

### G. Solid Electrolyte Layer Forming Step

The step of forming solid electrolyte layer 10 (solid electrolyte layer forming step) in the present embodiment is basically the same as the above E. Positive Electrode Layer Forming Step in the forming method except that the material to be used is changed to a material for solid electrolyte layer 10. Solid electrolyte layer 10 in the present embodiment is formed by, for example, coating solid electrolyte 2 in a film shape.

In the step of forming solid electrolyte layer 10, solid electrolyte 2 selected from the materials described in B-1. Solid Electrolyte is used. Specifically, the solid electrolyte material used for first material 21 and second material 22 constituting solid electrolyte 2 is selected from the materials described in B-1. Solid Electrolyte. Then, solid electrolyte 2 and a binder as necessary are mixed and dispersed in an organic solvent to prepare a slurry. The solid electrolyte layer can be prepared by the same method as the above method (1) in E. Positive Electrode Layer Forming Step except that the obtained slurry is coated onto positive electrode layer 20 and/or negative electrode layer 30 prepared above.

In an example shown in FIG. 2, solid electrolyte 2 is coated onto positive electrode layer 20 and negative electrode layer 30 in a film shape, but solid electrolyte 2 is not limited to this, and may be coated onto either of positive electrode layer 20 and negative electrode layer 30 in a film shape. In addition, solid electrolyte layer 10 may be prepared on a substrate such as a polyethylene terephthalate (PET) film by the above method, and obtained solid electrolyte layer 10 may be stacked on positive electrode layer 20 and/or negative electrode layer 30.

Here, solid electrolyte 2 used for forming solid electrolyte layer 10 will be described. Solid electrolyte 2 used for forming solid electrolyte layer 10 is formed by, for example, the stirring and kneading step of stirring and mixing first material 21 and second material 22 in a dry manner. A purpose of the stirring and kneading step is to form solid electrolyte 2 having a structure in which second material 22 partially covers the surface of the particles of first material 21 before forming solid electrolyte layer 10.

In the stirring and kneading step, solid electrolyte 2 is formed by kneading first material 21 and second material 22 in a dry manner by applying a pressing force and a shearing force. Specifically, first, first material 21 and second material 22 are selected from the solid electrolyte materials described in B-1. Solid Electrolyte. As first material 21 and second material 22, for example, solid electrolyte particles are selected.

Then, the solid electrolyte particles constituting first material 21 are taken as first particles, the solid electrolyte particles constituting second material 22 are taken as second particles, and the first particles and the second particles are mixed. In other words, first material 21 including the first particles and second material 22 including the second particles are mixed. In the present embodiment, a configuration in which first material 21 includes only the first particles and second material 22 includes only the second particles will be described below. Here, the volume ratio of second material 22 to the total volume of first material 21 including the first particles and second material 22 including the second particles in mixing is, for example, 5% or more and 50% or less.

The average particle diameter of the first particles is, for example, 0.5 μm or more and 1.0 μm or less. In the present specification, the average particle diameter is a number average particle diameter obtained by obtaining Feret diameters of the particles from an image obtained by image observation with an electron microscope, and obtaining a number average. In addition, the ionic conductivity of first material 21 including of the first particles is, for example, 3 mS/cm or more and 5 mS/cm or less.

The average particle diameter of the second particles is smaller than the average particle diameter of the first particles. Accordingly, the first particles partially covered with the second particles can be easily obtained, and the mixing ratio of first material 21 and second material 22 is likely to be controlled, so that stable battery performance can be obtained. The average particle diameter of the second particles is, for example, 0.01 μm or more and 0.1 μm or less. In addition, the ionic conductivity of second material 22 including the second particles is lower than the ionic conductivity of first material 21 including the first particles. The ionic conductivity of second material 22 including the second particles is, for example, 0.01 mS/cm or more and 0.3 mS/cm or less.

As a method of mixing the first particles and the second particles, for example, the first particles and the second particles are mixed and stirred while charging the second particles into a mixing and stirring device containing the first particles, and thereby the first particles and the second particles in the mixing and stirring device are kneaded in a dry manner by applying a pressing force and a shearing force by compression. At this time, a method of charging the second particles may be a method of repeatedly charging the second particles little by little while performing stirring and mixing.

Here, since the second particles tend to agglomerate as the particle diameter becomes smaller, agglomerates of the second particles are crushed and the second particles are adhered to the surface of the first particles by the stirring and kneading step. Through the stirring and kneading step, it is possible to form a state where the second particles are partially densely formed as a pseudo film on the surface of the first particles. A reason why this state is important will be described later.

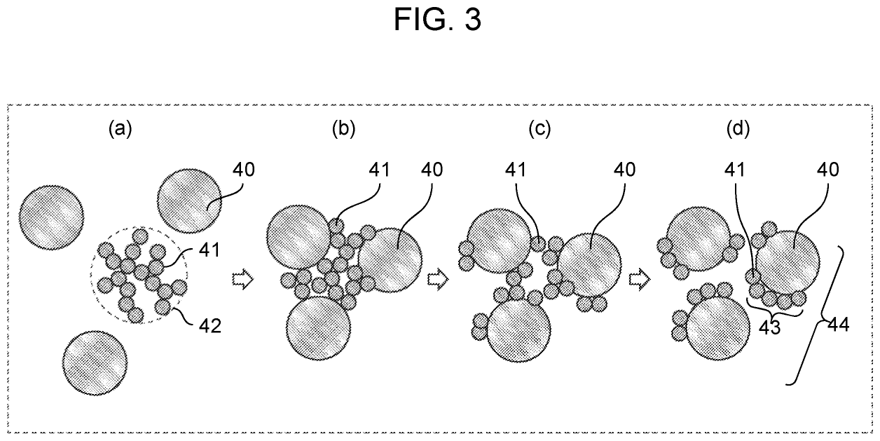

A behavior of the particles in the stirring and kneading step will be described with reference to FIG. 3. FIG. 3 is a schematic view showing a mixing behavior of the first particles and the second particles in the stirring and kneading step. First, as shown in (a) in FIG. 3, when first particles 40 and second particles 41 are charged into the mixing and stirring device, agglomerate 42 is likely to be formed to keep the surface energy stable since second particle 41 has a particle diameter smaller than that of first particle 40. Here, there is a possibility that a part of first particles 40 may form an aggregate, but since the particle diameter is larger than that of second particle 41, the agglomerate is less likely to be generated. Therefore, the particles are schematically shown as independent particles in FIG. 3.

Next, as shown in (b) and (c) in FIG. 3, when first particles 40 and second particles 41 are stirred while applying a compression pressure (pressing force) and a shearing force, agglomerate 42 of second particles 41 adheres to the surface of first particle 40 while being crushed by first particles 40. Finally, as shown in (d) in FIG. 3, covering film 43 in a state where second particles 41 are thinly and closely adhered to the surface of first particle 40 in a film shape is formed. Accordingly, second particles 41 cover a part of the surface of first particle 40 and are in contact with first particle 40. In addition, depending on hardness of the selected solid electrolyte material and conditions of the stirring and kneading step, second particles 41 may undergo plastic deformation by kneading and may have a dense film shape. The shape of second particles 41 may remain in a particle shape during charging, or the shape of second particles 41 may be deformed by the plastic deformation to form a dense film shape or the like.

By such a stirring and kneading step, for example, solid electrolyte mixture 44 including a mixture including first particles 40 covering a part of second particle 41 in a film shape, independently remaining first particles 40, and second particles 41 is formed. By using solid electrolyte mixture 44 thus formed as solid electrolyte 2, solid electrolyte layer 10 is formed by the above method.

Thus, in the stirring and kneading step, first material 21 including first particles 40 and second material 22 including second particles 41 are kneaded in a dry manner by applying a pressing force and a shear force, thereby forming solid electrolyte mixture 44 to be used as solid electrolyte 2. Accordingly, in solid electrolyte 2 used in solid electrolyte layer 10, a structure in which the surface of first particle 40 is covered with second particles 41 is stabilized.

In addition, in solid electrolyte layer 10 formed by using solid electrolyte 2 formed in the stirring and kneading step, for example, even if the mixing ratio of first particles 40 and second particles 41 at any position in the thickness direction of solid electrolyte layer 10 is obtained, the variation in the mixing ratio between positions is small. For example, when two types of particles, large and small, are mixed in a solvent, coated and dried to form the solid electrolyte layer, the mixing ratio of the two types of particles, large and small, may change due to the influence of convection in the coating film due to evaporation of the solvent. On the other hand, as in the present embodiment, by using solid electrolyte 2 formed by the stirring and kneading step in which first particles 40 and second particles 41 are stirred and mixed in advance in a dry manner and the surface of first particle 40 is covered with second particles 41, solid electrolyte layer 10 is subsequently formed in the state where the structure in which the surface of first particle 40 is coated with second particles 41 is likely to be kept. As a result, when solid electrolyte layer 10 is formed using solid electrolyte 2, a local mixing ratio between first particles 40 and second particles 41 is less likely to change in solid electrolyte layer 10. Therefore, when solid electrolyte layer 10 is formed, a change in mixing ratio of first particles 40 and second particles 41 in the thickness direction of solid electrolyte layer 10 described above can be prevented. For example, in the cross-sectional view when solid electrolyte layer 10 is cut in the thickness direction, the variation in volume ratio of second material 22 in the thickness direction of solid electrolyte layer 10 with respect to the total volume of first material 21 including first particles 40 and second material 22 including second particles 41 is 10% or less. Accordingly, stable battery characteristics can be obtained. Here, the expression “the variation is 10% or less” means that, in the case where an area occupied by first material 21 and second material 22 is obtained by electron microscope observation and the ratio of the area of second material 22 to a total area of first material 21 and second material 22 is obtained as the volume ratio, a difference in ratio (volume ratio) is 10% or less at any position in the thickness direction of solid electrolyte layer 10 with respect to an average value on entire solid electrolyte layer 10.

In addition, in the above manufacturing method, in order to generate a difference in ionic conductivity between first material 21 and second material 22, different solid electrolyte materials are selected for first material 21 and second material 22, but the present disclosure is not limited to this. The method for manufacturing all-solid-state battery 100 may include a grinding step for forming second material 22. Specifically, in the grinding step, first material 21 (specifically, first particles 40) is grinded in the presence of oxygen to form second material 22 (specifically, second particles 41). Accordingly, since it is not necessary to prepare two types of stable solid electrolyte materials that do not react with each other for first material 21 and second material 22, second material 22 can be easily prepared. For example, an oxidizable solid electrolyte material such as a sulfide-based solid electrolyte or a halide-based solid electrolyte tends to have the material partially deteriorated when reacting with oxygen, resulting in a decrease in ionic conductivity. Therefore, in the grinding step, by grinding first particles 40 constituting first material 21 in an environment of a predetermined oxygen partial pressure, second particles 41 constituting second material 22 are formed as particles grinded while appropriately coming into contact with oxygen. In this case, the content ratio of oxygen in second material 22 is higher than the content ratio of oxygen in first material 21. The content ratio of oxygen is, for example, a molar ratio of oxygen atoms in the solid electrolyte material. The ionic conductivity of second material 22 can be adjusted by adjusting the oxygen partial pressure at the time of grinding first material 21 and adjusting the content ratio of oxygen in second material 22.

Second material 22 having a content ratio of oxygen higher than that of first material 21 may be particles formed by grinding the solid electrolyte material other than first material 21 in the oxygen atmosphere. Also in this case, the ionic conductivity of second material 22 can be easily adjusted.

### H. Stacking Step and Pressing Step

In the stacking step and the pressing step, positive electrode layer 20 formed on positive electrode current collector 6, negative electrode layer 30 formed on negative electrode current collector 7, and solid electrolyte layer 10, which are obtained by respective forming steps, are stacked (stacking step) such that solid electrolyte layer 10 is disposed between positive electrode layer 20 and negative electrode layer 30, and then pressed (pressing step) from the outer sides of positive electrode current collector 6 and negative electrode current collector 7, thereby obtaining all-solid-state battery 100.

A purpose of the pressing is to increase the density of positive electrode layer 20, negative electrode layer 30, and solid electrolyte layer 10. By increasing the density, lithium ion conductivity and electron conductivity can be improved in positive electrode layer 20, negative electrode layer 30, and solid electrolyte layer 10, and all-solid-state battery 100 having good battery characteristics can be obtained.

### Examples

Hereinafter, Examples of the solid electrolyte layer of the all-solid-state battery according to the present embodiment will be described, but the present embodiment is not limited to these Examples. Unless otherwise specified, each Example is carried out in a glove box in which dew point is controlled to −45° C. or lower, or in a dry room.

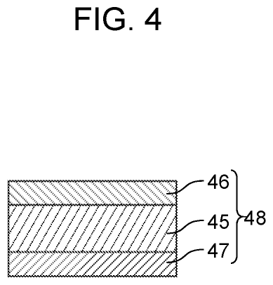

Specifically, in order to evaluate an effect of the solid electrolyte layer of the all-solid-state battery according to the present embodiment, a short-circuit test by simple dendrite generation was performed. FIG. 4 is a schematic view showing a cross section of evaluation sample 48 used in Comparative Example 1 and Example 1. As shown in FIG. 4, evaluation sample 48 includes first electrode 46, second electrode 47 disposed to face first electrode 46, and solid electrolyte layer 45 positioned between first electrode 46 and second electrode 47.

### (1) Preparation of Evaluation Sample 48 in Comparative Example 1

First, only first particles 40 made of a sulfide-based solid electrolyte as the solid electrolyte of solid electrolyte layer 45 were stacked so as to be sandwiched between first electrode 46 made of metal Li and second electrode 47 made of Cu. Next, the stacked structural body was adjusted and pressed under a pressure of 200 MPa to 300 MPa from above and below in the stacking direction. Accordingly, evaluation sample 48 in Comparative Example 1 having a structure in which solid electrolyte layer 45 formed by pressure-pressing first particles 40 was sandwiched between first electrode 46 and second electrode 47 was prepared.

### (2) Preparation of Evaluation Sample 48 in Example 1

Evaluation sample 48 in Example 1 was prepared in the same method as in the preparation of evaluation sample 48 in Comparative Example 1, except that a solid electrolyte formed by the stirring and kneading step using first particles 40 made of the sulfide-based solid electrolyte same as in Comparative Example 1 and second particles 41 made of a solid electrolyte material in which the content ratio of oxygen in the sulfide-based solid electrolyte was made, by the above method, higher than that of first particles 40 was used as the solid electrolyte of solid electrolyte layer 45. That is, solid electrolyte layer 45 of evaluation sample 48 in Example 1 has the configuration same as that of solid electrolyte layer 10 described above. At this time, the volume ratio of second particles 41 to the total volume of first particles 40 and second particles 41 was 15% to 25%.

### (3) Short-Circuit Test

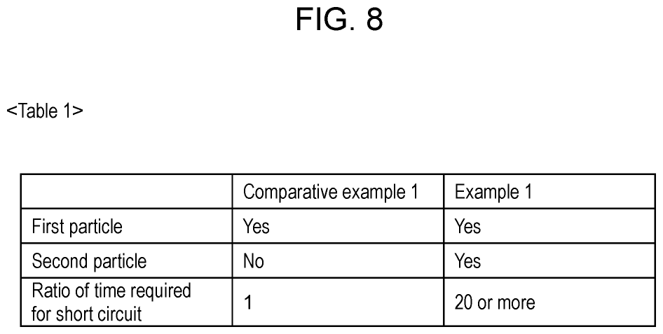

In obtained evaluation sample 48, a positive terminal was connected to first electrode 46 and a negative terminal was connected to second electrode 47, and a current of 0.1 mA to 0.4 mA, as a predetermined constant current assuming a current value flowing during the charge and discharge of the all-solid-state battery, was continuously applied to evaluation sample 48. When the constant current was continuously applied, the short circuit occurs due to dendrite generation and a voltage rapidly decreases, and thus a time required for the short circuit (in other words, the rapid decrease in voltage) from a start of application of the constant current was measured. Measured results are shown in Table 1 in FIG. 8. In Table 1, the “ratio of time required for short circuit” indicates the ratio when the time required for the short circuit between evaluation sample 48 in Comparative Example 1 and evaluation sample 48 in Example 1 is compared and the time in Comparative Example 1 is set to 1.

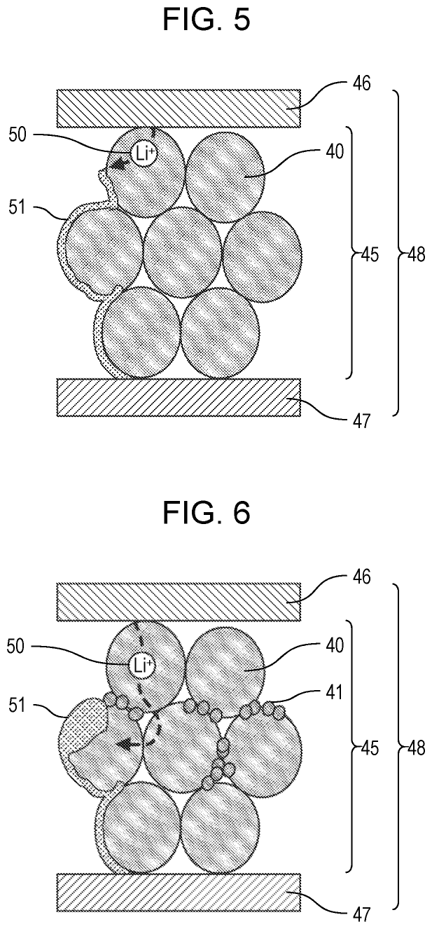

As shown in Table 1, it is confirmed that evaluation sample 48 in Example 1 does not generate the short circuit even after a time 20 times or more the time required until evaluation sample 48 in Comparative Example 1 is short-circuited, and has a lengthened time required for the short circuit. It is considered to be an effect that in solid electrolyte layer 45, second particles 41 having an ionic conductivity lower than that of first particles 40 are appropriately dispersed and present at a particle interface formed between first particles 40 which are solid electrolyte particles. A mechanism considered for a reason why this result is obtained will be described with reference to FIGS. 5 and 6.

FIG. 5 is a schematic view illustrating a generation state of dendrites in evaluation sample 48 in Comparative Example 1. FIG. 6 is a schematic view illustrating a generation state of dendrites in evaluation sample 48 in Example 1. FIG. 5 shows a cross section of evaluation sample 48 in Comparative Example 1, and FIG. 6 shows a cross section of evaluation sample 48 in Example 1. In FIGS. 5 and 6, the generation states of the dendrites inside solid electrolyte layer 45 sandwiched between first electrode 46 and second electrode 47 are schematically illustrated.

By applying the constant current to evaluation sample 48, Li ions 50 obtained by ionizing metal Li of first electrode 46 are conducted in first particles 40 constituting solid electrolyte layer 45. When reaching second electrode 47, Li ions 50 conducting in first particles 40 are deposited as the metal Li on the surface of second electrode 47. By continuously applying the constant current for a long time, the metal Li deposited on the surface of second electrode 47 grows as dendrite 51 along the particle interface of first particle 40 formed by plastic deformation of first particles 40 and the surface of first particles 40. At this time, in evaluation sample 48 in Comparative Example 1 shown in FIG. 5, Li ions 50 conducting in first particles 40 are intensively conducted to the metal Li present at the shortest distance, that is, at a location in dendrite 51 close to first electrode 46, and the metal Li is deposited at the location in dendrite 51 close to first electrode 46, so that dendrite 51 further grows. As a result, dendrite 51 is likely to grow from second electrode 47 toward first electrode 46 at the shortest distance in solid electrolyte layer 45. When grown dendrite 51 reaches first electrode 46, the short circuit occurs.

In contrast, in evaluation sample 48 in Example 1 shown in FIG. 6, the solid electrolyte material (second particles 41 in the figure) having an ionic conductivity lower than that of first particles 40 is present on the surface of first particles 40. Accordingly, second particles 41 are resistance components in the ionic conduction and promote dendrite 51 to bypass a conduction path of Li ions 50, which is considered to have an effect of preventing the growth of dendrite 51 at the shortest distance. That is, dendrite 51 grows along the surface of first particle 40 while bypassing the location where first particles 40 are covered with second particles 41. For example, dendrite 51 grows in a multi-branched manner. As a result, in evaluation sample 48 in Example 1, it is considered that grown dendrite 51 is less likely to reach first electrode 46, and the time required for the short circuit is lengthened. Therefore, even in all-solid-state battery 100 including solid electrolyte layer 10 having the configuration same as solid electrolyte layer 45 of evaluation sample 48 in Example 1, the occurrence of the short circuit can be prevented.

The configuration of solid electrolyte layer 10 in all-solid-state battery 100 for obtaining the effect of preventing the short circuit more efficiently will be described below.

The coverage rate of second material 22 (specifically, second particles 41 constituting second material 22) on the surface of first particle 40 is, for example, 5% or more and 62% or less. When the coverage rate is 5% or more, the growth of the dendrite described above is bypassed, and the effect of preventing the occurrence of the short circuit is likely to be obtained. When the coverage rate is 62% or less, the resistance components in the ionic conduction in solid electrolyte layer 10 are less likely to increase, and the efficiency of the battery is less likely to decrease. From the viewpoint of achieving both the prevention of the short circuit and the efficiency as the battery, the coverage rate may be 10% or more and 50% or less. The coverage rate is an average coverage rate of first particles 40, and is measured, for example, by observing an electron micrograph of solid electrolyte layer 10.

At the particle interface formed between first particles 40, for example, there is an interface where first particles 40 are in contact with each other. Accordingly, since second particles 41 are not present on the entire surface of the particle interface, the resistance components in the ionic conduction in solid electrolyte layer 10 can be reduced.

The ratio of the average particle diameter of second particles 41 to the average particle diameter of first particles 40 is, for example, 1% or more and 20% or less. When the ratio is 1% or more, second particles 41 are less likely to be aggregated, and the surface of first particles 40 is likely to be covered with second particles 41. When the ratio is 20% or less, the number of second particles 41 is ensured, and the surface of first particles 40 is likely to be covered with second particles 41. From the viewpoint that the surface of first particles 40 is more likely to be covered with second particles 41, the ratio may be 5% or more and 20% or less.

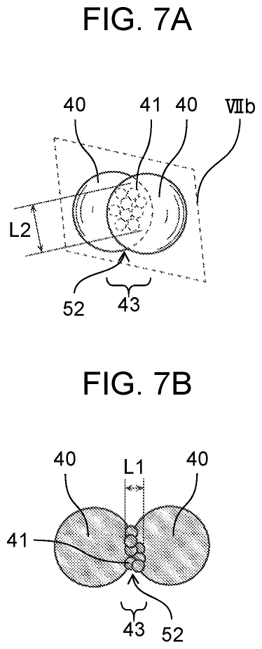

Here, the state where first particles 40 are covered with second particles 41 will be described with reference to FIGS. 7A and 7B. FIG. 7A is a perspective view schematically showing the state where first particles 40 are covered with second particles 41. FIG. 7B is a cross-sectional view of first particles 40 and second particles 41 shown in FIG. 7A cut along a surface VIIb indicated by a broken line. FIG. 7A shows the state where the surface of one particle of first particles 40 is covered with second particles 41 as covering film 43 and second particles 41 are sandwiched by another first particle 40. Here, in the covering structure of second material 22 which is covering film 43, i.e., second particles 41 covering the surface of first particles 40, a maximum value of a length of interface 52 formed between first particles 40 in a distance direction between first particles 40 (in other words, a normal direction of the particle surface of first particle 40) is set as covering thickness L1, and a maximum value of the length of interface 52 in a direction along interface 52 (in other words, the direction along the particle surface of first particle 40) is set as covering length L2. In at least one of covering structures (here, covering film 43) of second particles 41 covering first particles 40, covering length L2 with respect to covering thickness L1 is, for example, 10 times or more. Accordingly, it is likely to obtain the effect of bypassing the growth of the dendrite described above while preventing the increase in resistance components in the ionic conduction in the thickness direction of covering film 43.

The volume ratio of first material 21 including first particles 40 and second material 22 including second particles 41 is, for example, 5% or more and 50% or less. When the volume ratio is 5% or more, the effect of bypassing the growth of the dendrite described above is likely to be obtained. When the volume ratio is 50% or less, the resistance components in the ionic conduction in solid electrolyte layer 10 are less likely to increase, and the efficiency of the battery is less likely to decrease. From the viewpoint of achieving both the prevention of the short circuit and the efficiency as the battery, the volume rate may be 10% or more and 30% or less.

The ratio of the ionic conductivity of second material 22 including second particles 41 to the ionic conductivity of first material 21 including first particles 40 is, for example, 0.2% or more and 10% or less. When the ratio is 10% or less, the effect of bypassing the growth of the dendrite described above is likely to be obtained. When the ratio is 0.2% or more, the resistance components in the ionic conduction in solid electrolyte layer 10 are less likely to increase, and the efficiency of the battery is less likely to decrease.

As described above, the all-solid-state battery according to the present disclosure has been described based on the embodiments, but the present disclosure is not limited to these embodiments. The embodiments in which a person skilled in the art applies various modifications to the embodiments and other forms that are constructed by combining some of the components in the embodiments are also included in the scope of the present disclosure within a range not departing from the gist of the present disclosure.

For example, in the above embodiment, an example in which the ions conducting through solid electrolyte layer 10 are lithium ions has been described, but the present disclosure is not limited thereto. The ions conducting through solid electrolyte layer 10 may be ions other than the lithium ions such as sodium ions, magnesium ions, potassium ions, calcium ions, or copper ions.

The all-solid-state battery according to the present disclosure is expected to be applied to various batteries, such as a power source of a mobile electronic device, and an in-vehicle battery.

What is claimed is:

1. An all-solid-state battery, comprising:
a positive electrode current collector;
a positive electrode layer containing a positive electrode active material and a first solid electrolyte;
a solid electrolyte layer containing a third solid electrolyte;
a negative electrode layer containing a negative electrode active material and a second solid electrolyte; and
a negative electrode current collector,
wherein the positive electrode current collector, the positive electrode layer, the solid electrolyte layer, the negative electrode layer, and the negative electrode current collector are stacked in this order,
the third solid electrolyte contains a first material and a second material having an ionic conductivity lower than an ionic conductivity of the first material,
the first material comprises first particles, and
at least a part of a surface of the first particles is covered with the second material.

2. The all-solid-state battery of claim 1, wherein
a coverage rate of the second material on the at least a part of the surface of the first particles is 5% or more and 62% or less.

3. The all-solid-state battery of claim 1, wherein
the second material comprises second particles having an average particle diameter smaller than an average particle diameter of the first particles.

4. The all-solid-state battery of claim 3, wherein
a ratio of the average particle diameter of the second particles to the average particle diameter of the first particles is 1% or more and 20% or less.

5. The all-solid-state battery of claim 1, wherein
in a covering structure of the second material covering the first particles, a covering length with respect to a covering thickness is 10 times or more.

6. The all-solid-state battery of claim 1, wherein
a volume ratio of the second material to a total volume of the first material and the second material is 5% or more and 50% or less.

7. The all-solid-state battery of claim 1, wherein
in a cross-sectional view of the solid electrolyte layer, a variation in a volume ratio of the second material to a total volume of the first material and the second material in a thickness direction of the solid electrolyte layer is 10% or less.

8. The all-solid-state battery of claim 1, wherein
a content ratio of oxygen in the second material is higher than a content ratio of oxygen in the first material.

9. The all-solid-state battery of claim 1, wherein
a ratio of the ionic conductivity of the second material to the ionic conductivity of the first material is 0.2% or more and 10% or less.

10. A method for manufacturing the all-solid-state battery of claim 1, comprising:
a stirring and kneading step of forming the third solid electrolyte by kneading the first material and the second material in a dry manner by applying a pressing force and a shearing force before forming the solid electrolyte layer.

11. The method for manufacturing an all-solid-state battery of claim 10, further comprising:
a grinding step of forming the second material by grinding the first material in presence of oxygen before the stirring and kneading step.
